(19) United States
(12) Patent Application Publication
(10) Pub. No.: US 2017/0015242 A1
(43) Pub. Date: Jan. 19, 2017

(54) METHOD AND SYSTEM TO WARN OF A VEHICLE MOVING IN THE WRONG DIRECTION OF TRAVEL

(71) Applicant: Robert Bosch GmbH, Stuttgart (DE)

(72) Inventors: Bettina Rentel, Giesen/Emmerke (DE); Christian Jeschke, Beilstein (DE)

(21) Appl. No.: 15/206,721

(22) Filed: Jul. 11, 2016

(30) Foreign Application Priority Data
Jul. 17, 2015 (DE) 102015213481.4

(51) Int. Cl. B60Q 9/00; G08G 1/0967

(52) U.S. Cl. CPC B60Q 9/008; G08G 1/096775

(57) ABSTRACT

A method to warn of a vehicle moving in the wrong direction of travel. The method includes a step of the providing of first warning information by a server external to the vehicle to an interface with a communication device assigned to a further vehicle, when the vehicle moving in the wrong direction of travel is at a first distance from the further vehicle, and a step of the providing of second warning information to the interface with the communication device assigned to the further vehicle when the vehicle moving in the wrong direction of travel is at a second distance from the further vehicle, the second distance being less than the first distance.

### CROSS REFERENCE

The present application claims the benefit under 35 U.S.C. §119 of German Patent Application No. DE 102015213481.4 filed on Jul. 17, 2015, which is expressly incorporated herein by reference in its entirety.

### BACKGROUND INFORMATION

In case of an accident, wrong-way drivers, also known as ghost drivers, cause deaths, injuries and considerable material damage. For example, methods for detecting a wrong-way driver are based on the use of a video sensor system to detect the passing of a “no entry” sign, or on the use of a digital map in conjunction with a route navigation to detect a wrong direction of travel on a highway section that is open to traffic only in one direction. In addition, wireless methods are feasible that detect wrong-way drivers with the aid of infrastructure such as bars in or at the edge of the roadway.

Over half the instances of wrong-way travel begin at interchanges of federal highways. Especially during wrong-way travel on freeways, accidents occur at high collision speed, often accompanied by injuries resulting in death.

### SUMMARY

In accordance with the present invention, a method is provided to warn of a vehicle moving in the wrong direction of travel, a system that uses this method, and a corresponding computer program.

A method to warn of a vehicle moving in the wrong direction of travel, the method being graduated in the form of a “warning cascade” as a function of the development of an acute endangerment by the wrongly moving vehicle, is able to provide improved reaction possibilities as well as a better overview of the situation for the occupants of further vehicles located in the danger zone.

The present invention makes it possible to estimate wrong-way travel of a vehicle at a particularly early point in time during the wrong-way travel, in the best case, before a wrong-way driver—with high traveling speed and great probability of a collision—is already in the wrong lane of a federal highway, for example.

A method is introduced to warn of a vehicle moving in the wrong direction of travel, the method having the following steps:

Providing of first warning information by a server external to the vehicle to an interface with a communication device assigned to a further vehicle, when the vehicle moving in the wrong direction of travel is at a first distance from the further vehicle; and

Providing of second warning information to the interface with the communication device assigned to the further vehicle when the vehicle moving in the wrong direction of travel is at a second distance from the further vehicle, the second distance being less than the first distance.

The vehicle moving in the wrong direction of travel may be a road-going vehicle that is moving counter to a driving direction permitted for a roadway used by the vehicle, for example, entering a federal highway in the wrong driving direction. In particular, the vehicle moving in the wrong direction of travel may be a vehicle on a collision course with the further vehicle or with several further vehicles. The server external to the vehicle may be a data-processing device that is remote from the wrongly moving vehicle and the further vehicle and is coupled via a wireless connection as the interface, e.g., a radio link, to the vehicles or to communication devices located in the vehicles.

The first and second warning information may be understood to be signal data generated in the server and pertaining to the wrongly moving vehicle, the signal data possibly having been generated by the server using data concerning the wrong-way travel made available by the wrongly moving vehicle. The warning information may represent relevant features of the wrong-way travel by the wrongly moving vehicle and/or strategies to evade the wrongly moving vehicle or to avoid a collision with the wrongly moving vehicle. In this context, the second warning information may be characterized by a higher level of urgency than the first warning information, or the second warning information may represent a higher danger level than the first warning information.

The communication device may be an apparatus, located in the further vehicle, which allows the further vehicle or an occupant of the further vehicle to communicate wirelessly via the interface with the server. The communication device may be permanently installed in the further vehicle, e.g., in the form of or as part of a navigation system of the further vehicle, or may be assigned to an occupant in the further vehicle. For instance, the communication device may then be a cell phone or smartphone or a tablet computer of the occupant.

This method to warn of a vehicle moving in the wrong direction of travel may be implemented in software or hardware, for example, or in a mixed form of software and hardware, e.g., in a control unit.

According to one specific embodiment of the method, in the step of providing the first warning information, the first warning information may include a warning text and/or instantaneous position data of the vehicle moving in the wrong direction of travel. With the aid of the warning text and possibly the position data, specific recommendations and instructions for avoiding a collision may be conveyed to an occupant of the further vehicle, e.g., the driver. The position data may also be helpful to the occupant in rating the acute danger potential and exploring possible evasion options.

For instance, the method may have a step of outputting the warning text and/or the instantaneous position data to an occupant of the further vehicle via a loudspeaker of the communication device assigned to the further vehicle, as a speech message with the aid of a text-to-speech system. A text-to-speech system may be understood to be a system for speech synthesis, thus, the conversion of text to speech. This specific embodiment may advantageously ensure that at no time during the important phase of avoiding a collision with the wrong-way driver, does the driver of the further vehicle need to turn his eye away from the traffic situation.

For example, in the step of outputting the warning text and, additionally or alternatively, the instantaneous position data to the occupant of the further vehicle as a speech message, the speech message may be output in a language selected in the communication device assigned to the further vehicle. It may thus be ensured that the occupant understands the content of the speech message and is able to take suitable measures to avoid a collision.

Alternatively, the warning text and/or the position data may be provided to the occupant via a screen display of the communication device. The occupant may then look at the communication device at the moment best for him, in order to read the information displayed there several times, if desired.

It is also beneficial if, in the step of providing the first warning information and/or the step of providing the second warning information, the first warning information includes first acoustic information for a first acoustical signal and the second warning information includes second acoustic information for a second acoustical signal. For example, the acoustical signals may be made available to the occupant of the further vehicle in addition to the warning text and/or the position data. The provision of the acoustic information creates the possibility of alerting the occupant with great urgency about an approaching danger because of a ghost driver, without at the same time distracting him from the traffic situation.

Accordingly, the method may have a step of outputting the first acoustical signal and/or the second acoustical signal to an occupant of the further vehicle. In so doing, the first acoustical signal may be formed to be output in a first predetermined frequency and/or a first predetermined pitch and/or a first predetermined volume via a loudspeaker of the communication device, and the second acoustical signal may be formed to be output in a second predetermined frequency and/or a second predetermined pitch and/or a second predetermined volume via the loudspeaker of the communication device. The frequency may be understood to be a number of repetitions of the signal output in a predetermined period of time. In order to show clearly to the occupant of the further vehicle that the endangerment potential owing to the wrong-way driver has increased, e.g., the distance to the wrong-way driver has shortened, the second predetermined frequency may be higher than the first and/or the second pitch may be higher than the first and/or the second volume may be greater than the first.

In the same way, in the step of providing the first warning information and/or the step of providing the second warning information, the first warning information may include first visual information for a first visual signal and the second warning information may include second visual information for a second visual signal. For example, the visual signals may be made available to the occupant of the further vehicle in addition to the warning text and/or the position data and/or the acoustical signals. The provision of the visual information may create an additional possibility for drawing the attention of the occupant to an approaching danger by a ghost driver.

Accordingly, the method may have a step of outputting the first visual signal and/or the second visual signal to an occupant of the further vehicle. In this context, the first visual signal may be formed to be output in a first predetermined frequency via a light source of the communication device and the second visual signal may be formed to be output in a second predetermined frequency via the light source of the communication device. For example, the light source may be a flashing light integrated, for instance, into the communication device, if the communication device is a cell phone of the occupant. The frequency may be understood to be a number of repetitions of the signal output in a predetermined period of time. The occupant is advantageously able to perceive the visual signal provided in this form, from the corner of his eye. He does not need to turn his attention away from the traffic situation to do so.

According to a further specific embodiment, in the step of the providing of the second warning information and/or in a step of the providing of third warning information by the server external to the vehicle to the interface with the communication device assigned to the further vehicle, when the vehicle moving in the wrong direction of travel is at a third distance from the further vehicle, the third distance being less than the second distance, then the second and/or third warning information may include visual display information for a visual display of instantaneous position data of the vehicle moving in the wrong direction of travel. The provision of the visual information for a visual display of instantaneous position data of the wrong-way driver is able to effectively assist the driver of the further vehicle in selecting the strategy suitable for avoiding a collision.

Accordingly, the method may have a step of outputting the visual display signal for the visual display of the position data to an occupant of the further vehicle. In so doing, the visual display signal may be formed to be output as a visual representation of the instantaneous position data of the vehicle moving in the wrong direction of travel compared to visualized instantaneous position data of the further vehicle on a screen display of the communication device assigned to the further vehicle. Thus, the driver of the further vehicle is advantageously able to monitor exactly where his vehicle is in relation to the wrongly moving vehicle, how fast the wrongly moving vehicle is approaching, or whether the wrongly moving vehicle is still moving or has stopped.

It is also beneficial if, in the step of providing the first warning information and/or the step of providing the second warning information, at least one piece of the warning information is information for avoiding the vehicle moving in the wrong direction of travel. With this specific embodiment, the further vehicle may advantageously be directed safely onto a collision-avoiding course.

The approach presented here also provides a system which is designed to carry out, control or implement the steps of a variant of a method presented here in suitable devices. The object of the present invention may be achieved quickly and efficiently by this embodiment variant of the present invention in the form of a system, as well. In this context, the system may relate to the server, or may include both the server and the vehicle driving in the wrong direction and/or the further vehicle.

In the present case, the devices of the system may be understood to be electrical units which process sensor signals and output control- and/or data signals as a function thereof. The devices may have interfaces which may be implemented in hardware and/or software. In the case of a hardware implementation, the interfaces may be part of what is termed a system ASIC, for example, that includes a wide variety of functions of the apparatus. However, it is also possible for the interfaces to be separate, integrated circuits or to be made up at least partially of discrete components. If developed in software, the interfaces may be software modules which, for example, are available in a microcontroller in addition to other software modules.

Also of advantage is a computer-program product or computer program having program code that may be stored on a machine-readable carrier or storage medium such as a semiconductor memory, a hard-disk storage or an optical memory, and is used to carry out, implement and/or control the steps of the method according to one of the previously described specific embodiments, especially when the program product or program is executed on a computer or an apparatus or a device.

In connection with the approach described, in addition to the detection of a wrong-way driver, e.g., using conventional means, different reactions to the wrong-way driver may be carried out. Examples for this are the warning of the wrong-way driver himself via a display or acoustic advisories. Other drivers in the vicinity of a wrong-way driver may be warned, as well, e.g., via vehicle-to-vehicle communication or with the aid of mobile radio communication. In addition, it is possible to warn other highway users via variable message signs erected at the edge of the road, or an intervention in the engine control or brakes of the wrongly moving vehicle may be implemented.

Exemplary embodiments of the present invention are shown in the figures and explained in greater detail below.

### BRIEF DESCRIPTION OF THE DRAWINGS

FIG. 1 shows a schematic representation of a system to warn of a vehicle moving in the wrong direction of travel according to one exemplary embodiment.

FIG. 2 shows a schematic representation of a communication device participate in the system from FIG. 1 according to one exemplary embodiment.

FIG. 3 shows a schematic representation of a back side of a communication device participate in the system from FIG. 1 according to one exemplary embodiment.

FIG. 4 shows a schematic representation of a front side of a communication device participate in the system from FIG. 1 according to one exemplary embodiment.

FIG. 5 shows a flowchart of a method to warn of a vehicle moving in the wrong direction of travel according to one exemplary embodiment.

### DETAILED DESCRIPTION OF EXAMPLE EMBODIMENTS

In the following description of preferred exemplary embodiments of the present invention, the same or similar reference numerals are used for the similarly functioning elements shown in the various figures, a repeated description of these elements being omitted.

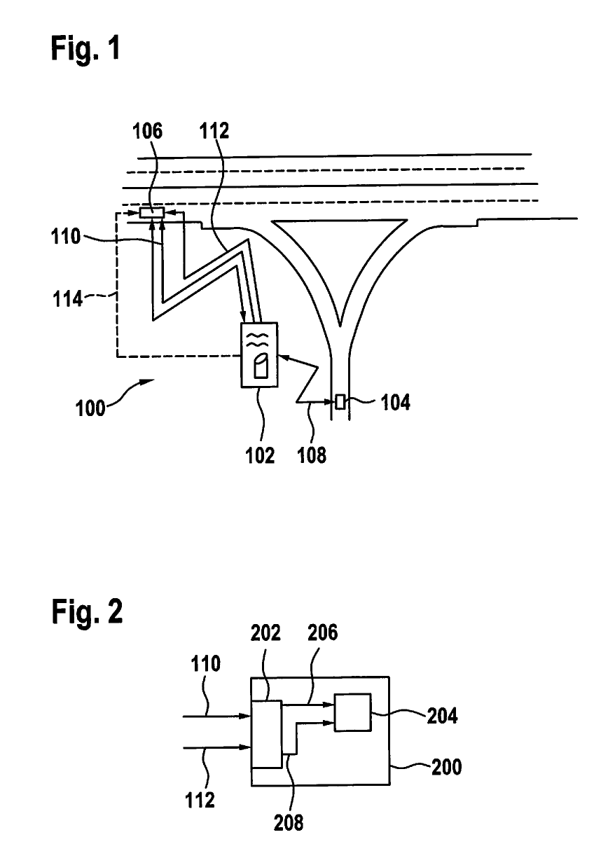

FIG. 1 shows a schematic representation of a system 100 to warn of a vehicle moving in the wrong direction of travel according to one exemplary embodiment. Exemplary system 100 includes a server 102, a vehicle 104 and a further vehicle 106. Server 102 is a data-processing device which is remote from vehicles 104, 106, and is connected to vehicles 104, 106 via a wireless connection, here, a radio link. Vehicles 104, 106 are road-going vehicles such as automobiles or trucks.

Vehicles 104, 106 each communicate using a communication apparatus or a communication device—not shown in FIG. 1—with server 102 via suitable interfaces. Depending on the exemplary embodiment, an on-board control unit or a mobile user terminal assigned to an occupant of respective vehicle 104, 106 may form the communication device communicating with server 102. If a communication device is an on-board variant, it may be installed permanently in respective vehicle 104, 106. If a mobile device or mobile user terminal is used, it may be a smartphone or a tablet computer of the occupant of respective vehicle 104, 106, for instance. In exemplary system 100 shown in FIG. 1, further vehicle 106 is representative for a multiplicity of further vehicles 106 that communicate wirelessly with server 102, and possibly with vehicle 104, as well.

Vehicle 104 represents a vehicle 104 moving in the wrong direction of travel. The scenario illustrated in FIG. 1 shows this by depicting vehicle 104 as a vehicle entering a federal highway in the wrong direction. Consequently, it is on a collision course with further vehicle 106 already moving in the correct direction on the federal highway.

FIG. 1 shows how system 100 introduced here is utilized for the third-party warning of further highway users 106 jeopardized by wrong-way driver 104, according to one exemplary embodiment. As soon as vehicle 104 is detected as wrong-way driver 104, it makes contacts with central server 102, e.g., via mobile radio communication. Server 102 determines an instantaneous position 108 of wrong-way driver 104. In addition, server 102 determines whether further vehicles 106 are in proximity of wrong-way driver 104 and now makes contact—e.g., again via mobile radio communication—with the at least one further vehicle 106.

If vehicle 104 is detected as wrong-way driver 104, then server 102 provides first warning information 110 to an interface—not shown in FIG. 1—here an air interface, with the communication device assigned to further vehicle 106, when vehicle 104 moving in the wrong direction of travel is at a first distance from further vehicle 106. When vehicle 104 moving in the wrong direction of travel is at a second distance from further vehicle 106, thus, the distance between vehicles 104, 106 has decreased, server 102 provides second warning information 112 to the interface with the communication device assigned to the further vehicle.

According to one exemplary embodiment of system 100, first warning information 110 includes a warning text as well as ascertained position data 108 of wrong-way driver 104. In one exemplary embodiment, the warning text as well as position data 108 may be output on a screen display of the communication device assigned to further vehicle 106.

According to another exemplary embodiment of system 100, first warning information 110 is output in the form of a voice message or speech message via a loudspeaker of the communication device assigned to further vehicle 106. For example, the speech message includes a name of a road or even a name and a number of an interchange at which vehicle 104 moving in the wrong direction of travel is currently located. The voice message may be read out to the occupant of further vehicle 106 via text-to-speech, for instance. According to one exemplary embodiment, the text-to-speech message may be given in several languages, e.g., as a function of the country setting selected in the communication device.

In order to give the driver of further vehicle 106 the possibility of correctly evaluating the gravity of the situation, according to a further exemplary embodiment of system 100, in addition to the text-to-speech message, an acoustic indication is also given which conveys to the driver of further vehicle 106, the distance further vehicle 106 is from wrong-way driver 104. For example, the acoustic indication may appear in the form of a brief warning tone that is output on the loudspeaker of the communication device. A frequency and/or a pitch and/or a volume of the warning tone may vary as a function of the level presently reached in the warning cascade. The acoustic indication may be provided with first warning information 110 and/or second warning information 112.

According to one exemplary embodiment, there is a long pause between two warning tones when further vehicle 106 is at a distance of more than one kilometer from wrong-way driver 104. The pause is shortened when the distance of vehicles 104, 106 from each other is between one kilometer and 500 meters, and the pause becomes very short when the distance between vehicles 104, 106 is less than 500 meters and the highest level of attentiveness is necessary on the part of the occupant of further vehicle 106.

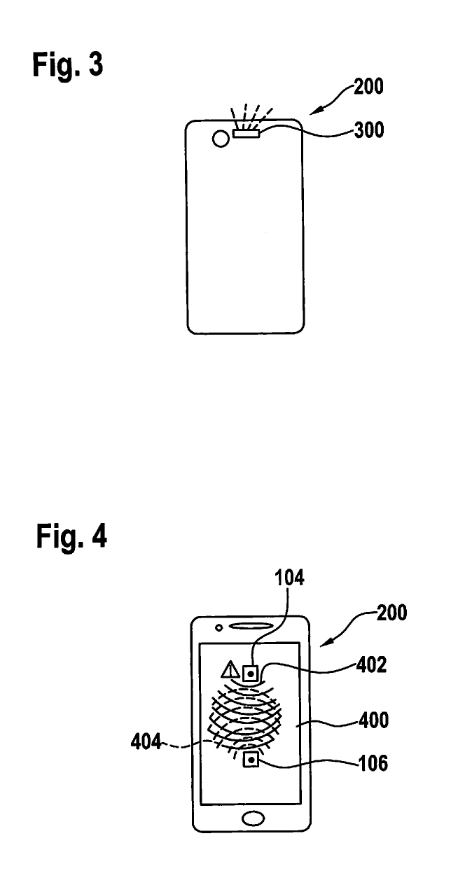

According to a further exemplary embodiment, in addition to the acoustic bolstering, a flashing and a frequency of the flashing light of the communication device assigned to the occupant of the further vehicle are set. This visual indication in the form of a visual signal may be provided with first warning information 110 and/or second warning information 112. Visual first warning information 110 and/or second warning information 112 is/are discussed in greater detail below in connection with FIG. 3.

At the highest expansion level of the HMI (human-machine interface) warning cascade described herein for a third-party warning of wrong-way drivers, according to a further exemplary embodiment, a visual representation of respective instantaneous positions of vehicles 104, 106 appears on a display of the communication device of further vehicle 106. This visual indication in the form of the display of the positions of vehicles 104, 106 may be provided with second warning information 112 and/or optional third warning information 114, e.g., by the depiction of spreading waves as in the case of sonar or radar. This is discussed in greater detail below in connection with FIG. 4.

If further vehicle 106 that is to receive the third-party warning is still relatively far away, e.g., several kilometers to approximately one kilometer, from wrong-way driver 104—in the scenario shown in FIG. 1, thus, before the interchange which wrong-way driver 104 is entering—, then the warning cascade proceeding in the receiver of further vehicle 106 may be adjusted accordingly: If further vehicle 106 is far distance-wise before the entrance ramp of wrong-way driver 104, and if a further exit ramp, a parking place or a service area exists between further vehicle 106 and wrong-way driver 104, then this may likewise be displayed to the driver of further vehicle 106 in the sense of a preventive warning strategy together with first warning information 110 and/or second warning information 112.

With the advantageous warning strategy proposed herein in the event a wrong-way travel is detected are also directions and advice to be heeded by the driver of further vehicle 106 as to how one should behave as driver if one receives a ghost-driver message—e.g., over the radio, as well. It may be important to reduce driving speed, so that in case of emergency, one can more safely swing out (make way) without skidding. It is also advisable to change to the right traffic lane. One could also refrain from further passing maneuvers. If the volume of traffic is heavy, care should be taken that one is driving in a manner offset relative to vehicles in the adjacent lane, and is maintaining sufficient distance to the vehicle in front. The hazard warning signal system should be switched on. The safest is to head into a parking place, a service area or an exit ramp in the immediate vicinity and to wait there until the all-clear signal is given.

FIG. 2 shows a schematic representation of an exemplary embodiment of communication device 200, participate in the system from FIG. 1, of the further vehicle jeopardized by the wrong-way driver.

Exemplary communication device 200 is a mobile user terminal 200, here a smartphone 200, assigned to an occupant of the further vehicle. Communication device 200 has an interface 202—here an air interface 202—with the remote server as well as a loudspeaker 204. Initially first warning information 110 and subsequently second warning information 112 is provided by the server to communication device 200 via interface 202.

In the exemplary embodiment shown in FIG. 2, communication device 200 is designed to signal first warning information 110 and/or second warning information 112 acoustically on communication device 200. Accordingly, using first warning information 110, a first acoustical signal 206 is made available at loudspeaker 204 of communication device 200, and using second warning information 112, a second acoustical signal 208 is made available at loudspeaker 204 of communication device 200.

Both signals 206, 208 are formed to generate several warning tones, set apart in time, on loudspeaker 204 to draw the attention of the occupant acoustically to the approach of the wrong-way driver. In so doing, in accordance with the warning cascade proposed herein, a time interval between two warning tones generated by first acoustical signal 206 is longer than a time interval between two warning tones generated by second acoustical signal 208. Thus, the frequency of the warning tones increases as the distance from the wrong-way driver decreases.

Alternatively, the warning cascade may also be realized in a different manner acoustically, e.g., by a changing pitch or volume of the warning tones output.

FIG. 3 shows a schematic representation of a back side of an exemplary communication device 200 participate in the system from FIG. 1. A mobile user terminal in the form of a smartphone 200 is used as communication device 200 assigned to the further vehicle here, as well. The back side of smartphone 200 shown in FIG. 3 has a flashing light 300 disposed behind a small transparent window in the upper section of mobile device 200.

According to the exemplary embodiment shown in FIG. 3, with the aid of the first and/or second warning information, the occupant of the further vehicle assigned to communication device 200 is alerted optically or visually of a decreasing spatial distance between the further vehicle and the wrong-way driver, and specifically, by an increasing frequency of activations of flashing light 300. Instead of flashing light 300, another light source 300 of communication device 200, e.g., an LED, may also be used to implement this variant of the warning cascade.

FIG. 4 shows a schematic representation of a front side of an exemplary communication device 200 in the form of a smartphone 200 participate in the system from FIG. 1. The front side of smartphone 200 shown in FIG. 4 has a display or a screen 400 for displaying optical or visual information. In the exemplary embodiment of the HMI warning cascade introduced herein and shown in FIG. 4, the occupant of the further vehicle is alerted to the approaching wrong-way driver using a visual display of information on screen 400 of smartphone 200.

As the representation in FIG. 4 shows, a first—upper in FIG. 4—vehicle symbol on screen display 400 symbolizes vehicle 104 moving in the wrong direction of travel. A second—lower in FIG. 4—vehicle symbol symbolizes further vehicle 106 moving in the correct direction of travel. To improve the correct assignment of vehicle symbols 104, 106 by the occupant, in the exemplary embodiment shown in FIG. 4, the symbol for wrong-way driver 104 is also supplemented by a symbol of a warning sign.

Vehicle symbols 104, 106 on screen display 400 are updated continuously in accordance with the instantaneous position data of the wrong-way driver provided by the server and instantaneous position data of further vehicle 106 provided by further vehicle 106, in order to display to the occupant of further vehicle 106, how far away wrongly moving vehicle 104 is, and the speed with which it is moving toward further vehicle 106. In addition, with the aid of the graphic representation, it is possible to identify whether wrong-way driver 104 is still moving or has already come to a standstill.

In the exemplary embodiment of a visual warning cascade shown in FIG. 4, to improve the assessment of the current distance by the occupant of further vehicle 106, signal waves 402 assigned to wrongly moving vehicle 104 and further signal waves 404 assigned to further vehicle 106 are shown on screen display 400. Here, a progressive overlap of signal waves 402, 404 signals an increasing risk of collision by wrong-way driver 104.

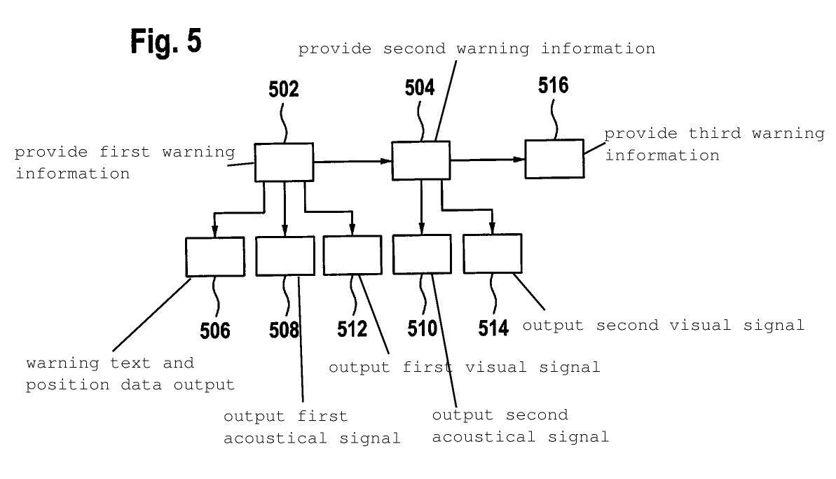

FIG. 5 shows a flowchart of an exemplary embodiment of a method 500 for triggering a suitable warning strategy for a third-party warning of further vehicles in the vicinity of a wrong-way driver. Method 500 may be implemented by an exemplary embodiment of the system shown in FIG. 1.

A main feature of method 500 introduced here is the implementation of a warning cascade which is characterized in that after a wrong-way driver has been detected, at least two different warning strategies are triggered in graduated fashion. According to the concept presented here, this is realized by a step 502 of providing first warning information to an interface with a communication device assigned to a further vehicle, and a subsequent step 504 of providing second warning information to the interface with the communication device. In this context, first step 502 of providing first warning information is carried out when the vehicle moving in the wrong direction of travel is at a first distance from the further vehicle, and second step 504 of providing second warning information is carried out when the vehicle moving in the wrong direction of travel is at a second shorter distance from the further vehicle.

According to one exemplary embodiment of method 500, the first warning information provided in step 502 includes a warning text as well as position data of the wrongly moving vehicle. A step 506 follows, in which the warning text as well as the instantaneous position data are output to an occupant of the further vehicle via a loudspeaker or a screen display of the communication device assigned to the further vehicle.

According to another exemplary embodiment of method 500, the first warning information provided in step 502 includes first acoustic information for a first acoustical signal, and the second warning information provided in step 504 includes second acoustic information for a second acoustical signal. In a step of outputting 508 the first acoustical signal, a first acoustical signal based on the first warning information is output via a loudspeaker of the communication device assigned to the further vehicle. In a step of outputting 510 the second acoustical signal, a second acoustical signal based on the second warning information and differing in frequency, pitch or volume from the first signal is output via the loudspeaker of the communication device.

Alternatively or additionally, the first warning information provided in step 502 includes first visual information for a first visual signal, and the second warning information provided in step 504 includes second visual information for a second visual signal. In a step of outputting 512 the first visual signal, a first visual signal based on the first warning information is output via a light source of the communication device assigned to the further vehicle. In a step of outputting 514 the second visual signal, a second visual signal based on the second warning information and differing in frequency from the first signal is output via the light source of the communication device.

According to a further exemplary embodiment, method 500 includes a step 516 of the providing of third warning information by the server external to the vehicle to the communication device assigned to the further vehicle, when the vehicle moving in the wrong direction of travel is at a third distance from the further vehicle, the third distance being less than the second distance, and the third warning information including visual display information for a visual display of instantaneous position data of the vehicle moving in the wrong direction of travel. Accordingly, this is followed by a step of outputting 518 a visual display, based on the visual display information, of instantaneous position data of the wrongly moving vehicle on a screen display of the communication device assigned to the further vehicle.

If an exemplary embodiment includes an “and/or” link between a first feature and a second feature, this is to be read in such a way that the exemplary embodiment according to one specific embodiment has both the first feature and the second feature, and according to a further specific embodiment, has either only the first feature or only the second feature.

What is claimed is:

1. A method to warn of a vehicle moving in the wrong direction of travel, the method comprising:
providing first warning information by a server external to the vehicle to an interface with a communication device assigned to a further vehicle, when the vehicle moving in the wrong direction of travel is at a first distance from the further vehicle; and
providing second warning information to the interface with the communication device assigned to the further vehicle, when the vehicle moving in the wrong direction of travel is at a second distance from the further vehicle, the second distance being less than the first distance.

2. The method as recited in claim 1, wherein, in the step of providing the first warning information, the first warning information includes at least one of a warning text and instantaneous position data of the vehicle moving in the wrong direction of travel.

3. The method as recited in claim 2, further comprising:
outputting the at least one of the warning text and the instantaneous position data to an occupant of the further vehicle via a loudspeaker of the communication device assigned to the further vehicle, as a speech message with the aid of a text-to-speech system.

4. The method as recited in claim 3, wherein, in the step of outputting the at least one of the warning text and the instantaneous position data to the occupant of the further vehicle as a speech message, the speech message is output in a language selected in the communication device assigned to the further vehicle.

5. The method as recited in claim 1, wherein, in at least one of the step of providing the first warning information and the step of providing the second warning information, the first warning information includes first acoustic information for a first acoustical signal and the second warning information includes second acoustic information for a second acoustical signal.

6. The method as recited in claim 5, further comprising:
at least one of: i) outputting the first acoustical signal, and ii) outputting the second acoustical signal to an occupant of the further vehicle, the first acoustical signal being formed to be output in at least one of: i) a first predetermined frequency, ii) a first predetermined pitch, and iii) a first predetermined volume, via a loudspeaker of the communication device (200), and the second acoustical signal being formed to be output in at least one of: i) a second predetermined frequency, ii) a second predetermined pitch, and iii) a second predetermined volume via the loudspeaker of the communication device.

7. The method as recited in claim 1, wherein in at least one of the step of providing the first warning information and the step of providing the second warning information, the first warning information includes first visual information for a first visual signal and the second warning information includes second visual information for a second visual signal.

8. The method as recited in claim 7, further comprising:
at least one of outputting the first visual signal and outputting the second visual signal, to an occupant of the further vehicle, the first visual signal being formed to be output in a first predetermined frequency via a light source of the communication device, and the second visual signal being formed to be output in a second predetermined frequency via the light source of the communication device.

9. The method as recited in claim 1, further comprising:
providing third warning information by the server external to the vehicle to the interface with the communication device assigned to the further vehicle, the third warning information being provided when the vehicle moving in the wrong direction of travel is at a third distance from the further vehicle, the third distance being less than the second distance, and at least one of the second and the third warning information includes visual display information for a visual display of instantaneous position data of the vehicle moving in the wrong direction of travel.

10. The method as recited in claim 9, further comprising:
outputting a visual display signal for the visual display of the position data to an occupant of the further vehicle, the visual display signal being formed to be output as a visual representation of the instantaneous position data of the vehicle moving in the wrong direction of travel compared to visualized instantaneous position data of the further vehicle on a screen display of the communication device assigned to the further vehicle.

11. The method as recited in claim 1, wherein in at least one of the step of providing the first warning information and the step of providing the second warning information, at least one piece of the warning information is information for avoiding the vehicle moving in the wrong direction of travel.

12. A system to warn of a vehicle moving in the wrong direction of travel, the system configured to:
provide first warning information by a server external to the vehicle to an interface with a communication device assigned to a further vehicle, when the vehicle moving in the wrong direction of travel is at a first distance from the further vehicle; and
provide second warning information to the interface with the communication device assigned to the further vehicle, when the vehicle moving in the wrong direction of travel is at a second distance from the further vehicle, the second distance being less than the first distance.

13. A non-transitory machine-readable storage medium, on which a computer program to warn of a vehicle moving in the wrong direction of travel is stored, the computer program, when executed by a processor, the processor causes:
providing first warning information by a server external to the vehicle to an interface with a communication device assigned to a further vehicle, when the vehicle moving in the wrong direction of travel is at a first distance from the further vehicle; and
providing second warning information to the interface with the communication device assigned to the further vehicle, when the vehicle moving in the wrong direction of travel is at a second distance from the further vehicle, the second distance being less than the first distance.
